(19) United States
(12) Patent Application Publication
(10) Pub. No.: US 2014/0280606 A1
(43) Pub. Date: Sep. 18, 2014

(54) Method and Apparatus for Content Management

(71) Applicant: Huawei Technologies Co., Ltd., Shenzhen (CN)

(72) Inventor: Youshui Long, Shenzhen (CN)

(73) Assignee: Huawei Technologies Co., Ltd., Shenzhen (CN)

(21) Appl. No.: 14/291,524

(22) Filed: May 30, 2014

Related U.S. Application Data
(63) Continuation of application No. PCT/CN2012/079280, filed on Jul. 27, 2012.

(30) Foreign Application Priority Data
Nov. 30, 2011 (CN) 201110390368.X

(51) Int. Cl. H04L 29/08

(52) U.S. Cl. CPC H04L 67/306
USPC 709/205

(57) ABSTRACT

A method and apparatus for content management are provided. A collaboration controller receives a stored content list sent by a network node. The stored content list includes an identifier and a popularity level of each content of a plurality of contents. The collaboration controller acquires identifiers and popularity levels of the plurality of contents from the stored content list, establishes a plurality of content list each of which includes identifiers of at least part of the plurality of contents that have a same popularity level, and manages each of the plurality of contents according to a corresponding popularity level.

### CROSS-REFERENCE TO RELATED APPLICATIONS

This application is a continuation of International Application No. PCT/CN2012/079280, filed on Jul. 27, 2012, which claims priority to Chinese Patent Application No. 201110390368.X, filed on Nov. 30, 2011, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of information technologies, and in particular, to a content management method, apparatus, and system.

### BACKGROUND

An initial implementation method of a network caching technology is a browser caching method. In this method, a browser of a client of each user has an independent buffer. In this way, requirements of users can be met to some extent; however, the same cache content is probably repeatedly stored in the buffers of different users, thereby resulting in unnecessary waste and limiting massive application of the method.

A proxy caching method makes an improvement to the foregoing browser caching method, where a set of physically close users may share a proxy cache server. By storing the content, the proxy cache server can serve more users and more effectively use a buffer.

However, cache content which can be stored by a single proxy cache server is limited, and the number of users that can be served by the proxy cache server is also limited. An extended proxy caching method in the prior art mainly includes the following: an Internet Cache Protocol (ICP) is an object location protocol, proxy cache servers communicate with each other through the ICP, and the proxy cache servers can use the ICP to send a query and a reply about whether there are Uniform Resource Locators (URLs) of content and about the optimal retrieval location of these URLs. In a typical ICP exchange, a proxy cache server sends an ICP query about a URL of the specific content to all neighboring proxy cache servers. Then, all the neighboring proxy cache servers return an ICP reply to indicate whether they contain a URL of the specific content. If these neighboring proxy cache servers do not contain the URL of the above specific content, these neighboring proxy cache servers return a “miss” message; and if these neighboring proxy cache servers contain the URL of the above specific content, these neighboring proxy cache servers return a “hit” message.

However, the conventional method may determine whether content exists, but a load imbalance problem exists between the proxy cache servers.

### SUMMARY

Embodiments of the present invention provide a method and apparatus for content, so as to utilize a storage space and save network bandwidth, and meanwhile ensure load balance between network nodes.

An embodiment of the present invention provides a collaboration controller. The collaboration controller includes a receiver and a processor. The receiver is configured to receive a stored content list sent by a network node. The stored content list includes an identifier and a popularity level of each content of a plurality of contents. The processor is coupled to the receiver and a non-transitory computer readable medium having a computer readable instruction stored thereon that, when executed by the processor, causes the processor to establish a plurality of content lists each of which includes identifiers of at least a part of the plurality of contents that have a same popularity level, and manage each of the plurality of contents according to a corresponding popularity level.

Another embodiment of the present invention provides a method for content management performed by a collaboration controller. The collaboration controller receives a stored content list sent by a network node. The the stored content list includes an identifier and a popularity level of each content of a plurality of contents. The collaboration controller acquires identifiers and popularity levels of the plurality of contents from the stored content list, establishes a plurality of content list each of which comprises identifiers of at least part of the plurality of contents that have a same popularity level, and manages each of the plurality of contents according to a corresponding popularity level.

Still another embodiment of the present invention provides a computer program product for use in a network device. The computer program product includes a non-transitory computer readable medium having computer readable instructions stored thereon that, when executed by a processor of the network device, cause the network device to implement the following: receiving a stored content list sent by a network node, the stored content list including an identifier and a popularity level of each content of a plurality of contents; acquiring identifiers and popularity levels of the plurality of contents from the stored content list; establishing a plurality of content list each of which comprises identifiers of at least part of the plurality of contents that have a same popularity level; and managing each of the plurality of contents according to a corresponding popularity level.

### BRIEF DESCRIPTION OF THE DRAWINGS

To illustrate the technical solutions in the embodiments of the present invention more clearly, the following briefly introduces the accompanying drawings for describing the embodiments. The accompanying drawings in the following description show some embodiments of the present invention, and a person of ordinary skill in the art may still derive other drawings from these accompanying drawings without creative efforts.

FIG. 1 is a schematic structural diagram of a cache collaboration system according to Embodiment 1 of the present invention;

FIG. 2 is a specific schematic structural diagram of a network node according to Embodiment 1 of the present invention;

FIG. 3 is a specific structural diagram of a collaboration controller according to Embodiment 1 of the present invention; and

FIG. 4 is a specific processing flow chart of a content management method according to Embodiment 2 of the present invention.

### DETAILED DESCRIPTION

To make the objectives, technical solutions, and advantages of the embodiments of the present invention more comprehensible, the following describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

To facilitate the understanding about the embodiments of the present invention, the present invention is further described by taking several specific embodiments as examples with reference to the accompanying drawings, and each embodiment does not limit the embodiments of the present invention.

### Embodiment 1

FIG. 1 shows a schematic structural diagram of a cache collaboration system provided in this embodiment, including a collaboration controller and at least one network node.

The network node has a function of storing content data, and can acquire popularity values of content according to access conditions of the content, attribute the stored content to different popularity levels according to the popularity values of the content, report a stored content list to a collaboration controller, and query information from the collaboration controller. Different network nodes can directly communicate with each other, share content resources, and mutually query and transmit the stored content. When not having content requested by a user, a network node may obtain the content described above from other network nodes in the system.

The collaboration controller receives the stored content list reported by the network node, and establishes and manages multiple content lists, where each of the content lists includes an identifier and a popularity value of each piece of content and each of the content lists is corresponding to a popularity level. The collaboration controller further provides a query interface for the network node.

The collaboration controller may be centralized or distributed. A centralized collaboration controller may be an independent server or a network node. A distributed collaboration controller is usually implemented by using a distributed hash table (DHT), a single collaboration controller and a network node may be located on a same physical device or on different physical devices.

FIG. 2 shows a specific structure of the above network node provided in this embodiment, including the following units.

A local cache management unit 21 is configured to store content data, acquire popularity values of the content according to access conditions of the content, and attribute stored content to different popularity levels according to the popularity values of the content. For example, the popularity of the stored content is sorted in descending order according to the access traffic within a set period, and the content is classified into popular content and unpopular content, namely, two popularity levels, according to positions in the sorting, where Top N contents are indicated as popular contents and contents following the Top N contents are unpopular contents. N is a positive integer and the value of N can be adjusted according to a load. When the load of the network node is high (e.g., overload), the value of N can be increased, and when the load of the network load is low (e.g., underload), the value of N may be decreased.

The local cache management unit 21 determines the number of stored copies of the content according to the popularity level of the content, where the number of stored copies of the content with a high popularity level is greater than the number of stored copies of the content with a low popularity level.

A collaborative message interaction interface unit 22 is configured to provide an interaction interface between the network node and the collaboration controller, and send, through the interaction interface, the stored content list, which is received from the collaborative message processing unit, to the collaboration controller.

The collaborative message processing unit 23 is configured to periodically send a stored content list to the collaboration controller through the collaborative message interaction interface unit 22, where the stored content list includes an identifier, a popularity value (optional), and a popularity level of each piece of the content.

Specifically, when the popularity level includes two levels, namely, an unpopular level and a popular level, the collaborative message processing unit 23 is further configured to, when the local cache management unit 21 needs to store new content, send a content query request for the new content to the collaborative message interaction interface unit 22. The collaborative message interaction interface unit 22 is further configured to send, through the interaction interface, the content query request, which is received from the collaborative message processing unit 23, to the collaboration controller, and send a query result, which is received from the collaboration controller through the interaction interface, to the collaborative message processing unit 23. The collaborative message processing unit 23 is further configured to notify the local cache management unit 21 to store the new content, when the query result received from the collaborative message interaction interface unit 22 is that the new content does not exist or the new content exists and has a popular popularity level; notify the local cache management unit 21 not to store the new content, when the query result received from the collaborative message interaction interface unit 22 is that the new content exists and has an unpopular popularity level; and afterwards, when a user requests the new content from the network node, the network node can acquire the new content from other network nodes.

Specifically, the collaborative message processing unit 23 is further configured to send a changed content query request for querying the content whose popularity level is changed from a popular level to an unpopular level to the collaborative message interaction interface unit 22, when the local cache management unit 21 needs to delete the stored content due to limitation on a storage space.

The collaborative message interaction interface unit 22 is further configured to send, through the interaction interface, the changed content query request, which is received from the collaborative message processing unit 23, to the collaboration controller, and send a changed content list, which is received from the collaboration controller through the interaction interface, to the collaborative message processing unit 23, where the changed content list includes an identifier and a popularity value of the content whose popularity level is changed from a popular level to an unpopular level.

The collaborative message processing unit 23 is further configured to, according to the changed content list received from the collaborative message interaction interface unit 22, notify the local cache management unit 21 to preferentially delete the locally stored content whose popularity level is an unpopular level and which is included in the changed content list, where the content properly has a content copy stored in the system because the content is ever popular.

As can be seen from the technical solutions provided in the embodiment of the present invention, the embodiment of the present invention can implement that the network node attributes the stored content to different popularity levels according to the access conditions of the content, and further implement that the network node can not only determine whether the content exists or not, but also identify the popularity level (an unpopular level or a popular level) of the content and the change of the popularity level, by querying in the collaboration controller. The network node can perform different processing according to the different popularity levels of the content. The popular content can have multiple copies to achieve load sharing; and the unpopular content has merely a single copy stored, so as to increase the total quantity of stored content.

FIG. 3 shows a specific structure of the above collaboration controller provided in this embodiment, including the following units.

A global cache management unit 31 is configured to acquire a popularity level of each piece of the content from the stored content list received from the collaborative message processing unit 33, and establish and manage multiple content lists, where each of the content lists includes an identifier of each piece of the content and an average popularity value (optional) at all network nodes, and each of the content lists is corresponding to a popularity level. The global cache management unit 31 needs to periodically update the content lists described above.

Specifically, when the popularity level includes two levels, namely, an unpopular level and a popular level, the global cache management unit 31 establishes and manages an unpopular content list, a popular content list, and a changed content list, where the popular content list includes an identifier and a popularity value of content which is sent by at least one network node and whose popularity level is a popular level, that is, if the content is popular at one network node, the content is attributed to the unpopular content list. The unpopular content list includes an identifier of content, which is sent by the network node and whose popularity level is an unpopular level and which does not exist in the popular content list, and further includes an average popularity value (optional) of the content at all the network nodes. The changed content list includes an identifier of content whose popularity level is changed from a popular level to an unpopular level and includes an average popularity value (optional) of the content at all the network nodes.

Meanwhile, the global cache management unit 31 above can further maintain the number of copies of each piece of the content and a ranking of average popularity according to a received cache content list of each network node. The content in the changed content list may be sorted according to a ratio of an average popularity value to the number of copies.

A collaborative message interaction interface unit 32 is configured to provide an interaction interface between the collaborative message interaction interface unit 32 and the network node, receive, through the interaction interface, the stored content list sent by at least one network node, and send the stored content list to the collaborative message processing unit 33.

A collaborative message processing unit 33 is configured to acquire the stored content list sent by at least one network node, where the stored content list includes an identifier, a popularity value (optional), and a popularity level of each piece of the content; and send the stored content list to the global cache management unit 31.

Specifically, the collaborative message interaction interface unit 32 is further configured to receive, through the interaction interface, a content query request sent by the network node, and send the content query request to the collaborative message processing unit 33.

The collaborative message processing unit 33 is further configured to query, according to the content query request, in a content list managed by the global cache management unit 31, and send a query result to the collaborative message interaction interface unit 32, where the query result includes the existence of the content and the popularity level of the content, or the non-existence of the content.

The collaborative message interaction interface unit 32 is further configured to return the query result, which is received from the collaborative message processing unit 33, to the network node.

Specifically, when the popularity level includes two levels, namely, an unpopular level and a popular level:

The collaborative message interaction interface unit 32 is further configured to receive, through the interaction interface, a changed content query request sent by the network node and used for querying the content whose popularity level is changed from a popular level to an unpopular level, and send the changed content query request to the collaborative message processing unit 33.

The collaborative message processing unit 33 is further configured to acquire, by querying according to the changed content query request, a changed content list managed by the global cache management unit 31, and send the changed content list to the collaborative message interaction interface unit 32.

The collaborative message interaction interface unit 32 is further configured to return, to the network node, the changed content list received from the collaborative message processing unit 33.

The apparatus according to the embodiment of the present invention may be a processor, for example, a central processing unit (CPU), or an application specific integrated circuit (ASIC).

As can be seen from the above technical solutions provided in the embodiment of the present invention, in the embodiment of the present invention, the collaboration controller establishes and manages the multiple content lists according to the stored content lists received from the network node, thereby implementing that the collaboration controller manages each piece of the content according to different popularity levels of the content. The collaboration controller returns the query result indicating the existence or non-existence of the carried content, the popularity level (an unpopular level or a popular level) of the content, and the change condition of the popularity level to the network node according to the query request received from the network node; in this way, it can be implemented that content with a high popularity level is stored at multiple network nodes, and that content with a low popularity level is merely stored at a few network nodes, thereby fully utilizing a storage space and saving network bandwidth, and meanwhile ensuring load balance between network nodes.

### Embodiment 2

This embodiment provides a content management method. FIG. 4 shows a specific processing flow chart of the method, including the following processing steps.

Step 41: A network node sends a stored content list to a collaboration controller, where the stored content list includes an identifier and a popularity level of each piece of content.

The network node implements the storage of the content, acquires popularity values of the content according to access conditions of the content, and attributes the stored content to different popularity levels according to the popularity values of the content. The network node sends the stored content list to the collaboration controller, where the stored content list includes an identifier and a popularity level of each piece of the content.

For example, the popularity of the stored content is sorted in descending order according to the access traffic within a set period, and the content is classified into popular content and unpopular content, namely, two popularity levels, according to positions in the sorting, where TopN pieces of the content are indicated as popular content and content following the Top N pieces of the content are unpopular content. N is a positive integer and the value of N can be adjusted according to a load. When the load of the network node is high (e.g., overload), the value of N may be increased, and when the load of the network load is low (e.g., underload), the value of N may be decreased.

Step 42: The collaboration controller acquires the stored content list sent by at least one network node, acquires a popularity level of each piece of the content according to the stored content list, and establishes and manages multiple content lists, where each of the content lists includes an identifier of each piece of the content and each of the content lists is corresponding to a popularity level.

When the popularity level includes two levels, namely, an unpopular level and a popular level, the collaboration controller may establish and manage an unpopular content list, a popular content list, and a changed content list. The popular content list includes an identifier of content which is sent by the at least one network node and whose popularity level is a popular level. The unpopular content list includes an identifier of content which is sent by the network node and whose popular level is an unpopular level and which does not exist in the popular content list. The changed content list includes an identifier of content whose popularity level is changed from a popular level to an unpopular level.

When the network node needs to store new content, the network node may send a content query request for the new content to the collaboration controller. The collaboration controller may query according to the content query request, in a content list managed by the collaboration controller, and send a query result to the network node. The query result includes existence of the content and the popularity level of the content, or non-existence of the content. When the query result is that the new content does not exist or the new content exists and has a popular popularity level, the network node stores the new content. When the query result is that the new content exists and has an unpopular popularity level, the network node does not store the new content.

When the network node needs to delete the stored content, the network node sends to the collaboration controller a changed content query request for querying content whose popularity level is changed from a popular level to an unpopular level. After the collaboration controller receives the changed content query request, the collaboration controller sends the changed content list managed by the collaboration controller to the network node. The network node deletes according to the changed content list received from the collaboration controller, the locally stored content whose popularity level is an unpopular level and which is included in the changed content list.

The apparatus according to the embodiment of the present invention may a processor, for example, a CPU, or an ASIC.

As can be seen from the technical solutions provided in the embodiment of the present invention, the embodiment of the present invention can implement that the network node attributes the stored content to different popularity levels according to the access conditions of the content, and further implement that the network node can not only determine whether the content exists or not, but also identify the popularity level (an unpopular level or a popular level) of the content and the change of the popularity level, by querying in the collaboration controller. The network node can perform different processing according to the different popularity levels of the content. The popular content can have multiple copies to achieve load sharing; and the unpopular content has merely a single copy stored, so as to increase the total quantity of stored content.

The collaboration controller establishes and manages the multiple content lists according to the stored content lists received from the network node, thereby implementing that the collaboration controller manages each piece of the content according to different popularity levels of the content. The collaboration controller returns the query result indicating existence or non-existence of the carried content, the popularity level (an unpopular level or a popular level) of the content, and the change condition of the popularity level to the network node according to the query request received from the network node; in this way, it can be implemented that content with a high popularity level is stored at multiple network nodes, and that content with a low popularity level is merely stored at a few network nodes, thereby fully utilizing a storage space and saving network bandwidth, and meanwhile ensuring load balance between network nodes.

A specific process of performing content management by using the method according to the embodiment of the present invention is similar to that in the embodiments of the above apparatus and system, and the details are not described herein again.

Those of ordinary skill in the art should understand that all or a part of the processes of the method according to the embodiments may be implemented by a computer program instructing relevant hardware. The program may be stored in a computer readable storage medium. When the program is run, the process of the method according to each of the embodiments is performed. The storage medium may be a magnetic disk, an optical disk, a read-only memory (ROM), or a random access memory (RAM).

To sum up, in the embodiments of the present invention, the collaboration controller establishes and manages multiple content lists according to the stored content list received from the network node, where each of the content lists includes an identifier of each piece of the content and each of the content lists is corresponding to a popularity level. It can be implemented that the collaboration controller manages each piece of the content according to different popularity levels of the content.

The collaboration controller returns the query result indicating existence or non-existence of the carried content, the popularity level (an unpopular level or a popular level) of the content, and the change condition of the popularity level to the network node according to the query request received from the network node; in this way, it can be implemented that content with a high popularity level is stored at multiple network nodes, and that content with a low popularity level is merely stored at a few network nodes, thereby fully utilizing a storage space and saving network bandwidth, and meanwhile ensuring load balance between network nodes.

It can be implemented that the network node attributes the stored content to different popularity levels according to the access conditions of the content. It can be further implemented that the network node can not only determine whether the content exists or not, but also identify the popularity level (an unpopular level or a popular level) of the content and the change of the popularity level, by querying in the collaboration controller. A local network node can perform different processing according to the different popularity levels of the content. The popular content can have multiple copies to achieve load sharing; and the unpopular content has merely a single copy stored, so as to increase the total quantity of stored content.

The foregoing description is merely about exemplary embodiments of the present invention, but is not intended to limit the protection scope of the present invention. Any variation or replacement made by persons skilled in the art without departing from the idea of the present invention shall fall within the protection scope of the present invention. Therefore, the protection scope of the present invention shall be subject to the claims.

What is claimed is:

1. A collaboration controller, comprising:
a receiver configured to receive a stored content list sent by a network node, wherein the stored content list comprises an identifier and a popularity level of each content of a plurality of contents; and
a processor coupled to the receiver and a non-transitory computer readable medium, wherein the non-transitory computer readable medium has a computer readable instruction stored thereon that, when executed by the processor, causes the processor to implement the following:
establishing a plurality of content lists, wherein each of the plurality of content lists comprises identifiers of at least part of the plurality of contents that have a same popularity level; and
managing each of the plurality of contents according to a corresponding popularity level.

2. The collaboration controller according to claim 1, wherein the plurality of content lists comprise an unpopular content list, a popular content list, and a changed content list, wherein the popularity level of the contents in the popular content list is a popular level, wherein the popularity level of the contents in the unpopular content list is an unpopular level, wherein the contents in the unpopular content list do not exist in the popular content list, and wherein the changed content list comprises contents whose popularity levels are changed from the popular level to the unpopular level.

3. The collaboration controller according to claim 1, wherein the receiver is further configured to receive a content query request sent by the network node, wherein the processor is further configured to query, according to the content query request, at least part of the content lists, and send a query result to the network node, wherein the query result comprises an existence of a content corresponding to the content query request and a popularity level of the content, or the query result comprises a non-existence of a content corresponding to the content query request.

4. The collaboration controller according to claim 1, wherein the receiver is further configured to receive from the network node a changed content query request for querying a content whose popularity level is changed from a popular level to an unpopular level, and wherein the processor is further configured to acquire the changed content list and send the changed content list to the network node.

5. A method for content management, comprising:
receiving, by a collaboration controller, a stored content list sent by a network node, wherein the stored content list comprises an identifier and a popularity level of each content of a plurality of contents;
acquiring, by the collaboration controller, identifiers and popularity levels of the plurality of contents from the stored content list;
establishing, by the collaboration controller, a plurality of content lists, wherein each of the plurality of content lists comprises identifiers of at least part of the plurality of contents that have a same popularity level; and
managing, by the collaboration controller, each of the plurality of contents according to a corresponding popularity level.

6. The method according to claim 5, wherein the plurality of content lists comprise an unpopular content list, a popular content list, and a changed content list, wherein the popularity level of the contents in the popular content list is a popular level, wherein the popularity level of the contents in the unpopular content list is an unpopular level, wherein the contents in the unpopular content list do not exist in the popular content list, and wherein the changed content list comprises contents whose popularity levels are changed from the popular level to the unpopular level.

7. The method according to claim 6, further comprising:
receiving, by the collaboration controller, a content query request sent by the network node; and
querying, by the collaboration controller according to the content query request, at least part of the plurality of content lists, and sending a query result to the network node, wherein the query result comprises an existence of a content corresponding to the content query request and a popularity level of the content, or the query result comprises a non-existence of a content corresponding to the content query request.

8. The method according to claim 6, further comprising:
receiving, by the collaboration controller, from the network node a changed content query request for querying a content whose popularity level is changed from the popular level to the unpopular level; and
sending, by the collaboration controller, the changed content list to the network node.

9. A computer program product for use in a network device, comprising a non-transitory computer readable medium having computer readable instructions stored thereon that, when executed by a processor of the network device, cause the network device to implement the following:
receiving a stored content list sent by a network node, wherein the stored content list comprises an identifier and a popularity level of each content of a plurality of contents;
acquiring identifiers and popularity levels of the plurality of contents from the stored content list;
establishing a plurality of content lists, wherein each of the plurality of content lists comprises identifiers of at least part of the plurality of contents that have a same popularity level; and
managing each of the plurality of contents according to a corresponding popularity level.

10. The computer program product according to claim 9, wherein the plurality of content lists comprise an unpopular content list, a popular content list, and a changed content list, wherein the popularity level of the contents in the popular content list is a popular level, wherein the popularity level of the contents in the unpopular content list is an unpopular level, wherein the contents in the unpopular content list do not exist in the popular content list, and wherein the changed content list comprises contents whose popularity levels are changed from the popular level to the unpopular level.

11. The computer program product according to claim 10, wherein when executed by the processor, the computer readable instructions further cause the network device to implement:
receiving a content query request sent by the network node;
querying according to the content query request, at least part of the plurality of content lists; and
sending a query result to the network node, wherein the query result comprises an existence of a content corresponding to the content query request and a popularity level of the content, or the query result comprises a non-existence of a content corresponding to the content query request.

12. The computer program product according to claim 10, wherein when executed by the processor the computer readable instructions further cause the network device to implement:
receiving from the network node a changed content query request for querying a content whose popularity level is changed from the popular level to the unpopular level; and
sending the changed content list to the network node.
